(19) United States
(12) Patent Application Publication
(10) Pub. No.: US 2014/0218384 A1
(43) Pub. Date: Aug. 7, 2014

(54) IMAGE PROCESSING APPARATUS AND CONTROL METHOD THEREOF

(71) Applicant: CANON KABUSHIKI KAISHA, Tokyo (JP)

(72) Inventor: Yasushi Ito, Yokohama-shi (JP)

(73) Assignee: CANON KABUSHIKI KAISHA, Tokyo (JP)

(21) Appl. No.: 14/153,649

(22) Filed: Jan. 13, 2014

(30) Foreign Application Priority Data
Feb. 4, 2013 (JP) 2013-019885
Dec. 17, 2013 (JP) 2013-260666

(51) Int. Cl. G09G 5/10

(52) U.S. Cl. CPC G09G 5/10
USPC 345/589

(57) ABSTRACT

An image processing apparatus comprises a recording image generation unit which generates recording image data from image data input by an image input unit, based on a first gamma characteristic; a display image generation unit which generates display image data from the image data based on a second gamma characteristic in correspondence with a characteristic of a display unit; a determination unit which determines whether or not the recording image data includes a portion of luminance levels which are not less than a predetermined threshold; a display data generation unit which generates display data for indicating the portion of the luminance levels which are not less than the predetermined threshold; and a display control unit which superimposes the display data on the display image data.

### BACKGROUND OF THE INVENTION

1. Field of the Invention

The present invention relates to an image processing apparatus which has a portion of luminance levels at which tones cannot be expressed on a display unit due to a latitude difference between a recording image and display image, and a control method thereof.

2. Description of the Related Art

Digital camera parameters include “latitude” as one important item. “Latitude” is a reproducible exposure range or tolerance level of an object, and is determined by settings of an exposure value using an aperture diaphragm and a gamma characteristic as in a dynamic range. A characteristic which can reproduce an image even by setting an exposure value that normally causes highlight-detail loss or shadow-detail loss is expressed as “wide latitude”. In case of such characteristic, smooth tones can be reproduced from a dark part to a bright part. Conversely, a characteristic with a narrow reproducible exposure range is expressed as “narrow latitude”. In this case, highlight-detail loss or shadow-detail loss is readily caused for overexposure or underexposure, but a high-contrast image can be obtained.

A wide variety of digital video cameras ranging from home use to professional use (for film/commercial production) are available, and concepts about latitudes of images to be recorded are different for respective users.

In home use of a digital video camera, an image is converted into and saved as latitude-restricted image data based on an exposure value using an aperture diaphragm and gamma characteristics at the time of developing processing in correspondence with a performance of a display unit such as a television monitor upon recording an image. By contrast, in professional use for filming, an image is recorded to have a wide latitude while utilizing a sensor performance of a digital video camera as much as possible, and the latitude is restricted in correspondence with the performance of the display unit at the time of editing.

FIG. 3 shows the configuration of a conventional home-use digital video camera in which latitudes of a recording image and display images are matched. In FIG. 3, image data captured by an image sensor 102 is converted by a developing processing unit 104 based on a desired developing gamma characteristic, and is recorded in a recording medium 107. On the other hand, image data to be displayed on a display unit 111 is obtained by converting output image data of the developing processing unit 104 by a gamma correction unit 108 based on display gamma characteristics which can attain a linear characteristic between object and display luminance values in correspondence with the characteristic of the display unit 111. The user adjusts an exposure value by an aperture diaphragm 101 based on an image, zebra pattern, or the like displayed on the display unit 111. The zebra pattern is an assist display required to notify the user that an output of a corresponding region of the image sensor is saturated by additionally displaying an oblique stripe pattern to that region corresponding to a predetermined luminance level to the image displayed on the display unit 111. Since other units will be described later as an embodiment (FIG. 1), a description thereof will not be given.

Japanese Patent Laid-Open No. 04-051381 describes a technique which extracts a maximum-level signal from R, G, and B image signal of an image sensor, and displays a zebra pattern on a display image within a saturation range of one of the R, G, and B image signals when any of the R, G, and B image signals exceeds a saturation detection level.

As described above, in professional use for filming, since a wide latitude of a recording image is assured, but a latitude of a display image is restricted to a gamma characteristic corresponding to the characteristic of a display unit, the recording image and display image have different latitudes. For this reason, an image signal of a latitude not less than that restricted by the display gamma characteristic causes a highlight-detail loss, and accurate exposure adjustment is difficult to attain upon confirmation of a captured image. Hence, it is desirable to make an assist display which allows the user to confirm a latitude difference between a recording image and display image.

### SUMMARY OF THE INVENTION

The present invention has been made in consideration of the aforementioned problem, and realizes a technique which allows the user to confirm a portion of luminance levels at which tones cannot be expressed on a display unit due to a latitude difference between a recording image and display image, and to attain accurate exposure adjustment.

In order to solve the aforementioned problems, the present invention provides an image processing apparatus comprising: a recording image generation unit configured to generate recording image data from image data input by an image input unit, based on a first gamma characteristic; a display image generation unit configured to generate display image data from the image data based on a second gamma characteristic in correspondence with a characteristic of a display unit; a determination unit configured to determine whether or not the recording image data includes a portion of luminance levels which are not less than a predetermined threshold; a display data generation unit configured to generate display data for indicating the portion of the luminance levels which are not less than the predetermined threshold; and a display control unit configured to superimpose the display data on the display image data.

In order to solve the aforementioned problems, the present invention provides an image processing apparatus comprising: a recording image generation unit configured to generate recording image data from image data input by an image input unit, based on a first gamma characteristic; a display image generation unit configured to generate display image data from the image data based on a second gamma characteristic, a latitude of which is narrower than the first gamma characteristic, wherein the display image data includes a portion in which tones of the recording image data are not reproduced due to the second gamma characteristic is narrower than the first gamma characteristic; and a display unit configured to superimpose display data for indicating that tones cannot be expressed on a portion in which tones of the recording image data cannot be reproduced and in which tones cannot be expressed even in the recording image data in the display image data.

In order to solve the aforementioned problems, the present invention provides a control method of an image processing apparatus, the method comprising the steps of: generating recording image data from image data input by an image input unit, based on a first gamma characteristic; generating display image data from the image data based on a second gamma characteristic in correspondence with a characteristic of a display unit; determining whether or not the recording image data includes a portion of luminance levels which are not less than a predetermined threshold; generating display data used to indicate the portion of the luminance levels which are not less than the predetermined threshold; and superimposing the display data on the display image data.

According to the present invention, the user can confirm a portion of luminance levels at which tones cannot be expressed on a display unit due to a latitude difference between a recording image and display image, and can attain accurate exposure adjustment.

Further features of the present invention will become apparent from the following description of exemplary embodiments (with reference to the attached drawings).

### BRIEF DESCRIPTION OF THE DRAWINGS

FIG. 1 is a block diagram showing the apparatus configuration of an embodiment according to the present invention;

FIG. 2 is a graph showing an example of a developing gamma characteristic;

FIG. 3 is a block diagram showing the conventional apparatus configuration;

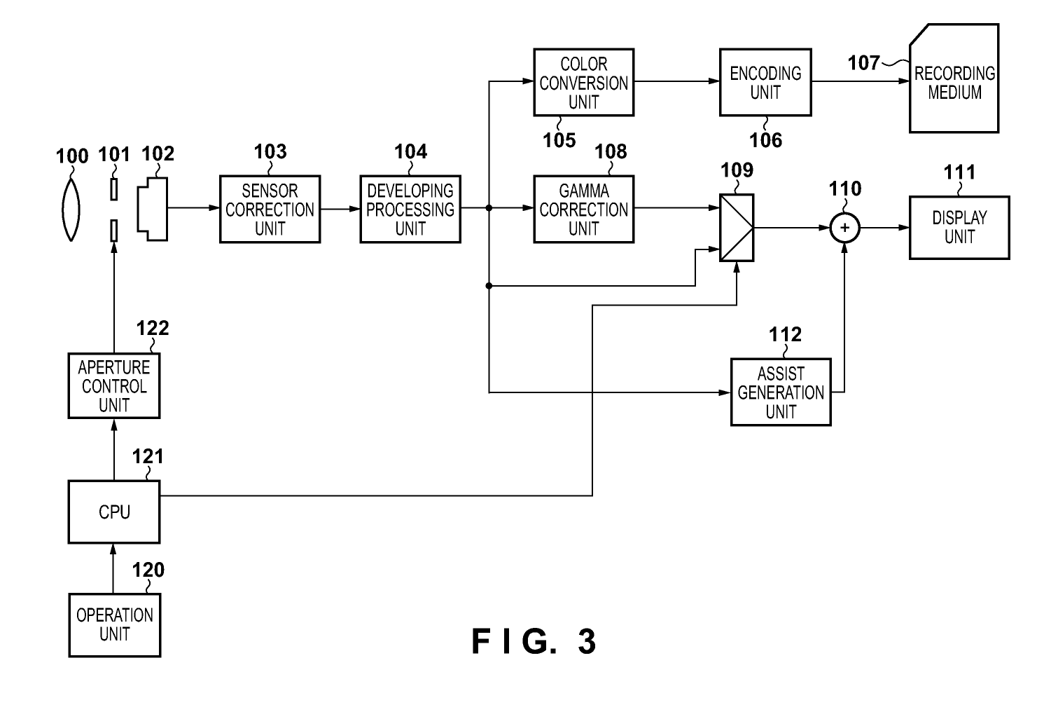

FIGS. 4A and 4B are graphs showing examples of developing gamma curves and latitudes; and

FIGS. 5A and 5B are views showing examples of assist displays using a zebra pattern.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

### First Embodiment

An embodiment in which an image processing apparatus of the present invention is applied to an image capturing apparatus such as a digital video camera for shooting a still image and moving image will be described hereinafter.

<Apparatus Configuration>

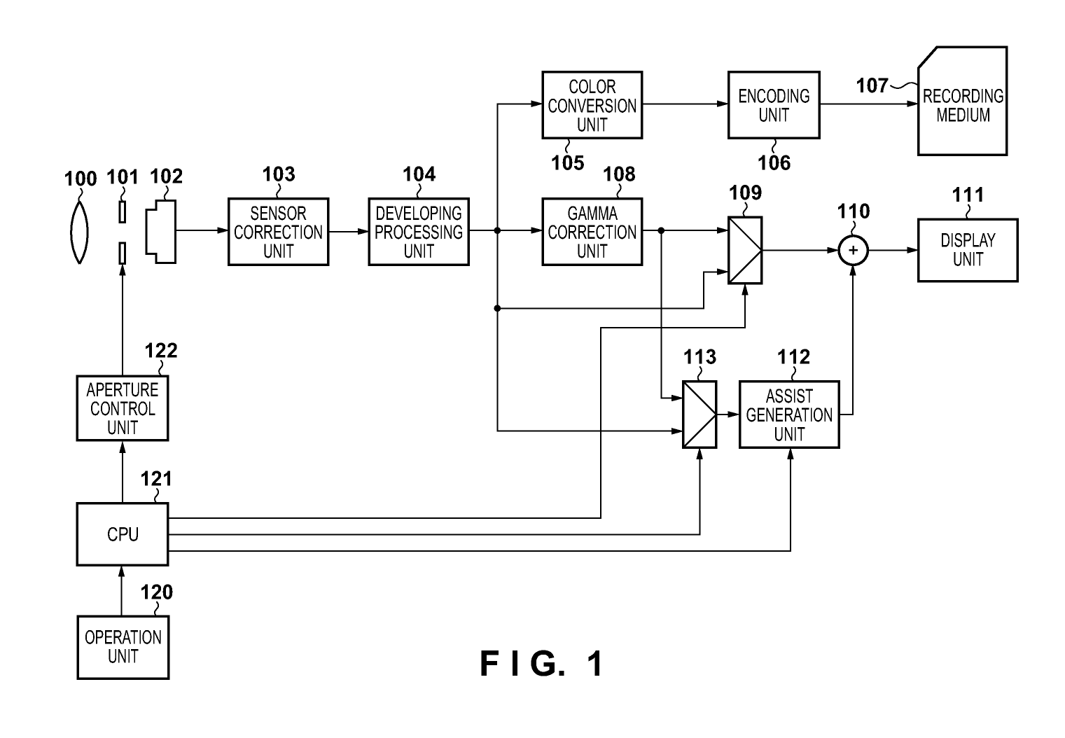

The configuration and functions of an image capturing apparatus according to an embodiment of the present invention will be described below with reference to FIG. 1.

Referring to FIG. 1, a shooting lens set 100 condenses an optical image of an object, and forms it on an image capturing surface of an image sensor 102 serving as an image input unit. An aperture diaphragm 101 adjusts an incoming light amount of the optical image of the object. The image sensor 102 is an image capturing element such as a CCD or CMOS. The image sensor 102 photoelectrically converts an object image formed by the shooting lens set 100 to generate an analog signal, and further converts the analog signal into a digital signal to be output. R (red), G (green), and B (blue) color filters are arranged on respective pixels of the image sensor in a predetermined layout (for example, a Bayer layout), and R, G, and B image signals are output for each color. In order to output image signals at high speed, pixel addition processing for adding several pixels as one pixel to reduce an output image may be executed to output R, G, and B image signals.

A sensor correction unit 103 applies processing for correcting aberrations caused by the shooting lens set 100 and that for interpolating defective pixels of the sensor to image data output from the image sensor 102.

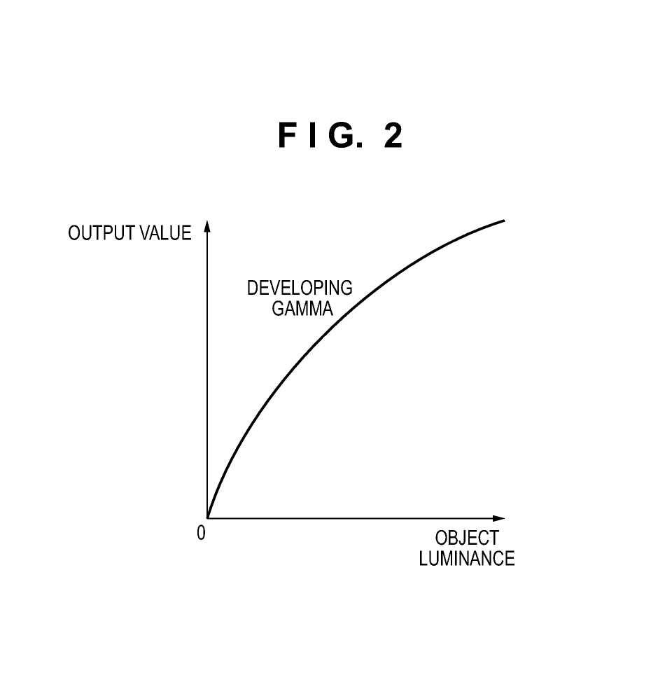

A developing processing unit 104 inputs R, G, and B image signals from the sensor correction unit 103, and executes offset adjustment, gain adjustment, interpolation processing of the Bayer layout or the like, developing gamma processing, and the like of respective signals. The developing gamma processing converts R, G, and B image signals to have a developing gamma curve exemplified in FIG. 2. The developing gamma curve is a characteristic selected to generate desired image data of the user in consideration of the characteristics of the shooting lens set 100 and image sensor 102. The user can arbitrary select a gamma curve from a plurality of gamma characteristics, and can generate a display image and an image which reproduces textures and tones of a cinema film by changing a developing gamma curve to a desired one.

A color conversion unit 105 converts R, G, and B image signals output from the developing processing unit 104 into a luminance signal (Y) and color difference signals (Cb, Cr). An encoding unit 106 inputs YCbCr signals, and compression-encodes the input signals in correspondence with a predetermined file format to generate recording image data. A recording medium 107 saves image data compression-encoded by the encoding unit 106.

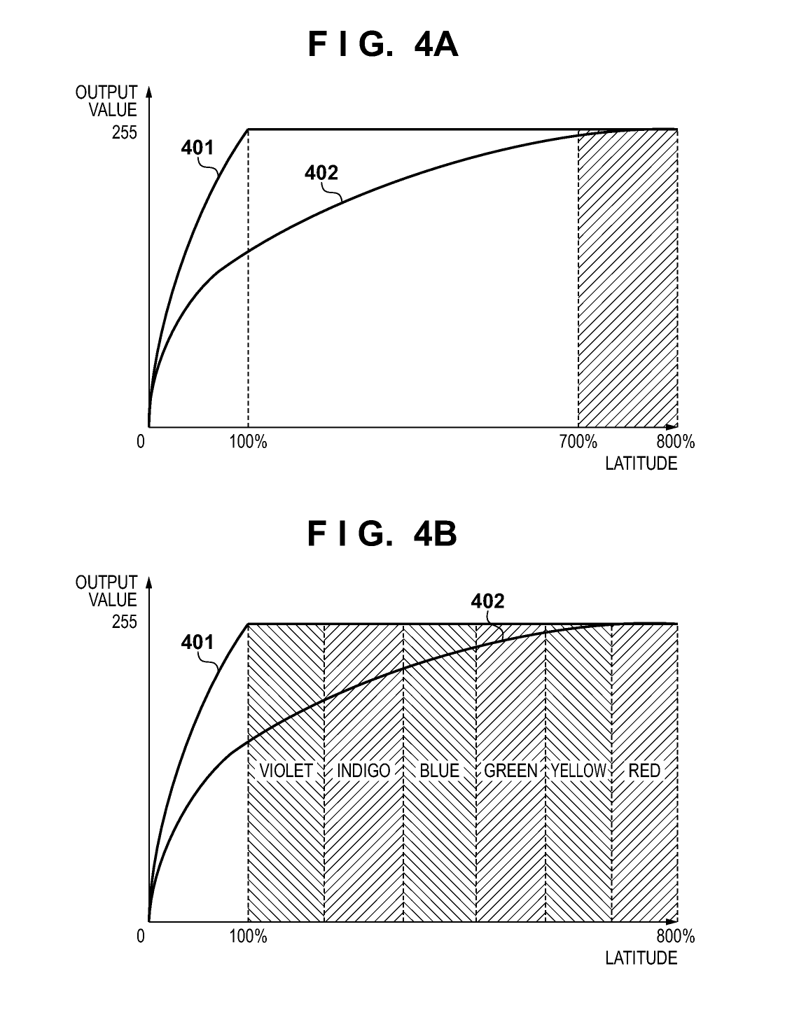

A gamma correction unit 108 converts R, G, and B image signals output from the developing processing unit 104 based on a gamma characteristic intended by the user, thus generating display image data. The user can arbitrarily select a gamma characteristic from a plurality of gamma characteristics. For example, when the display unit 111 has a characteristic of y=2.2,image signals output from the developing processing unit 104 are converted into those adjusted to the characteristic of y=2.2. The gamma correction unit 108 also assumes a role of restricting a latitude in correspondence with the characteristic of the display unit 111. For example, when a latitude to be displayed on the display unit 111 is 100%, even when a recording image has a latitude of 100% or more, a characteristic 401 which sets a maximum luminance level when the latitude=100% is used, as shown in FIG. 4A.

A gamma selection unit 109 selects according to a control command of a CPU 121 whether image data to be output to the display unit 111 is output image data of the developing processing unit 104 or that of the gamma correction unit 108. When a latitude is restricted, as described above, the CPU 121 switches the gamma selection unit 109 to select output image data of the gamma correction unit 108. Conversely, when a latitude is not restricted, the CPU 121 switches the gamma selection unit 109 to select output image data of the developing processing unit 104 without going through the gamma correction unit 108.

An assist generation unit 112 generates assist display data when it is determined that output image data of the developing processing unit 104 includes a portion of luminance levels which exceed a predetermined threshold. The assist display data is data required to clearly specify a luminance level portion which is unobservable in output image data of the gamma correction unit 108 and in which tones are unobservable even in output data of the developing processing unit 104.

Latitude differences when, for example, the gamma correction unit 108 uses a display gamma characteristic 401 and a developing gamma characteristic 402 of the developing processing unit 104 is that for a filming application will be described below with reference to FIGS. 4A and 4B.

In FIGS. 4A and 4B, the display gamma characteristic 401 forms a curve which reaches a maximum luminance level when a latitude=100%. The developing gamma characteristic 402 has a latitude=800% to broaden a latitude as much as possible. An image to be recorded in the recording medium 107 is image data having the latitude=800% depending on the developing gamma characteristic 402. An image to be displayed on the display unit 111 is image data, the latitude of which is restricted to 100% by the gamma correction unit 108 after being converted based on the developing gamma characteristic 402. For this reason, a highlight-detail loss is generated on the display unit 111 in a latitude range from 100% to 800%, and tones of a recording image cannot be reproduced.

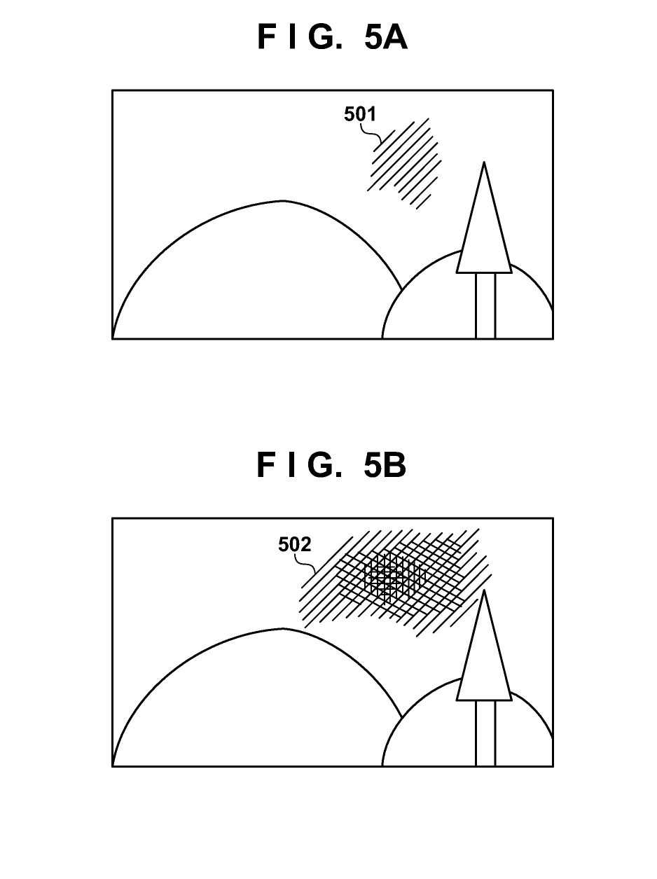

Also, the developing gamma characteristic 402 is often expressed by a curve which draws an upward convex arc, so as to enhance a characteristic in a low-luminance range. At this time, in a high-luminance range in which the developing gamma characteristic 402 is expressed by a nearly flat curve compared to the low-luminance range, a highlight-detail loss may also be generated in a recording image. Assuming that latitudes at which a highlight-detail loss may also be generated in a recording image range from 700% to 800%, a luminance level corresponding to a latitude=700% is set as a threshold m of the assist generation unit 112. Then, an oblique stripe zebra pattern 501 is displayed on a portion of luminance levels which exceed the threshold m in a recording image, as shown in FIG. 5A. Note that the threshold m can be arbitrarily set by the user using an operation unit 120 in accordance with the developing gamma characteristic 402. As for a portion where tones of a recording image cannot be expressed, a method of dividing a latitude range into arbitrary n ranges, and displaying color-coded ranges (FIG. 4B), a method of changing a pattern direction of the zebra pattern 502 (FIG. 5B), or a method which combines these methods as needed may be used.

An assist display selection unit 113 selects output image data of the developing processing unit 104 or that of the gamma correction unit 108 as output image data to the assist generation unit 112 according to a control command from the CPU 121. The output image data of the developing processing unit 104 is image data to be recorded having a wide latitude, as described above. On the other hand, the output image data of the gamma correction unit 108 is image data to be displayed, which is obtained by restricting a latitude of the output image data of the developing processing unit 104 in correspondence with the characteristic of the display unit 111.

A display composition unit 110 generates composite image data by superimposing assist display data on the output image data from the gamma selection unit 109, and outputs that image data to the display unit 111.

An aperture control unit 122 adjusts an aperture of the aperture diaphragm 101 using a stepping motor and the like as a driving source in accordance with an exposure value set by the user via the operation unit 120.

The CPU 121 controls the aforementioned blocks in accordance with an operation input to the operation unit 120.

The operation unit 120 includes various switches required for the user to operate the image capturing apparatus (a power ON/OFF switch, shooting start/end switch, and the like). In this embodiment, the operation unit 120 especially serves as a device for setting an aperture of the aperture diaphragm 101, setting the threshold m of the assist generation unit 112, selecting the developing gamma characteristic and display gamma characteristic, and making a switching operation of output image data in the gamma selection unit 109 and assist display selection unit 113.

As described above, according to this embodiment, a portion which is unobservable on the display unit 111 due to a highlight-detail loss and in which tones cannot be expressed even in a recording image due to a latitude difference of output image data of the developing processing unit 104 and gamma correction unit 108 can be clearly shown by the assist display.

Also, in this embodiment, a portion in which tones of a recording image cannot be reproduced due to a highlight-detail loss in display image data but in which tones can be expressed in a recording image may be assist-displayed using a form which can be distinguished from the assist-displayed zebra pattern as a portion in which tones are unobservable from the recording image. That is, referring to FIG. 4A, even a portion of luminance levels corresponding to a latitude range from 100% to 700% may be assist-displayed using, for example, a zebra pattern to be observable by the user, so as to be distinguished from a portion of luminance levels corresponding to a latitude range from 700% to 800%.

In order to implement the aforementioned function, the image capturing apparatus of this embodiment preferably includes an acquisition unit which acquires luminance levels for respective regions in association with display image data, and a determination unit which determines whether an acquired luminance level is included in a latitude range from 100% to 700% or that from 700% to 800%. In this case, the assist generation unit 112 generates assist display data for respective regions in accordance with the latitude range determined by the determination unit.

In this manner, even a portion in which tones of a recording image cannot be expressed due to a highlight-detail loss in display image data, but in which tones can be expressed in the recording image can be clearly shown to be distinguished from a portion in which tones cannot be expressed even in the recording image.

Note that as the generation method of assist display data which allows the user to distinguish a portion corresponding to the latitude range of 100% to 700% and a portion corresponding to the latitude range of 700% to 800% from each other, the aforementioned method for displaying color-coded ranges, the method of changing a direction of a zebra pattern, or the method which combines these methods as needed can be applied.

Furthermore, since a value of the latitude range of the developing gamma characteristic 402 relatively changes depending on the display gamma characteristic 401, a calculation unit which acquires information related to the display gamma characteristic 401 and calculates a value of the latitude range of the developing gamma characteristic 402 may be included.

For example, when an external display device which can set a latitude value other than 100% is used in place of the display unit 111, a highlight-detail loss region on display image data is different from the case using the display unit 111. In such case, the assist generation unit 112 can specify a portion in which a highlight-detail loss is generated in display image data but in which tones can be expressed in a recording image by comparing a gamma characteristic of the external display device and the developing gamma characteristic 402. In this case, when the latitude range in which tones cannot be expressed is divided into arbitrary n ranges, and the divided ranges are color-coded and displayed, the number of divisions may be changed according to a difference between the gamma characteristic of the external display device and the developing gamma characteristic 402. Alternatively, a highlight-detail loss region may be specified from signal levels of display image data which is converted using a display gamma characteristic for the external display device in place of information related to the gamma characteristic acquired from the external display device.

In the example of the aforementioned embodiment, the present invention is applied to the image capturing apparatus such as a digital video camera. However, the present invention is not limited to this, and is applicable to an apparatus which has a portion of luminance levels at which tones cannot be expressed on a display unit due to a latitude difference between a recording image and display image.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2013-019885, filed Feb. 4, 2013 and 2013-260666, filed Dec. 17, 2013, which are hereby incorporated by reference herein in their entirety.

What is claimed is:

1. An image processing apparatus comprising:
a recording image generation unit configured to generate recording image data from image data input by an image input unit, based on a first gamma characteristic;
a display image generation unit configured to generate display image data from the image data based on a second gamma characteristic in correspondence with a characteristic of a display unit;
a determination unit configured to determine whether or not the recording image data includes a portion of luminance levels which are not less than a predetermined threshold;
a display data generation unit configured to generate display data for indicating the portion of the luminance levels which are not less than the predetermined threshold; and
a display control unit configured to superimpose the display data on the display image data.

2. The apparatus according to claim 1, wherein said display image generation unit generates, as the display image data, image data, a latitude of which is restricted with respect to the recording image data.

3. The apparatus according to claim 1, further comprising an operation unit configured to accept an operation input from a user,
wherein the predetermined threshold is arbitrarily settable according to an operation input to said operation unit.

4. The apparatus according to claim 3, further comprising a storage unit configured to store a plurality of different gamma characteristics as the first gamma characteristic,
wherein the first gamma characteristic is arbitrarily selectable from the plurality of gamma characteristics according to an operation input to said operation unit.

5. The apparatus according to claim 1, further comprising a selection unit configured to select one of the recording image data and the display image data, and to output the selected image data to the display unit.

6. An image processing apparatus comprising:
a recording image generation unit configured to generate recording image data from image data input by an image input unit, based on a first gamma characteristic;
a display image generation unit configured to generate display image data from the image data based on a second gamma characteristic, a latitude of which is narrower than the first gamma characteristic,
wherein the display image data includes a portion in which tones of the recording image data are not reproduced due to the second gamma characteristic is narrower than the first gamma characteristic; and
a display unit configured to superimpose display data for indicating that tones cannot be expressed on a portion in which tones of the recording image data cannot be reproduced and in which tones cannot be expressed even in the recording image data in the display image data.

7. A control method of an image processing apparatus, the method comprising the steps of:
generating recording image data from image data input by an image input unit, based on a first gamma characteristic;
generating display image data from the image data based on a second gamma characteristic in correspondence with a characteristic of a display unit;
determining whether or not the recording image data includes a portion of luminance levels which are not less than a predetermined threshold;
generating display data used to indicate the portion of the luminance levels which are not less than the predetermined threshold; and
superimposing the display data on the display image data.

8. A non-transitory computer-readable storage medium storing a program for causing a computer to execute the control method according to claim 7.
